(19) United States
(12) Patent Application Publication
(10) Pub. No.: US 2022/0255759 A1
(43) Pub. Date: Aug. 11, 2022

(54) VERIFICATION PUSH NOTIFICATIONS THROUGH WEB-BROWSER

(71) Applicant: Twilio Inc., San Francisco, CA (US)

(72) Inventor: Carlos Estiben Hurtado Tamayo, Bogota Cundinamarca (CO)

(21) Appl. No.: 17/643,960

(22) Filed: Dec. 13, 2021

Related U.S. Application Data
(60) Provisional application No. 63/147,037, filed on Feb. 8, 2021.

(51) Int. Cl. H04L 9/32; H04L 9/08

(52) U.S. Cl. CPC H04L 9/3271; H04L 9/0861; H04L 9/3247

(57) ABSTRACT

Disclosed are systems, methods, and non-transitory computer-readable media for verification push notifications provided through a web-browser application. An authentication system provides a web-client Software Development Kit (SDK) to enable verification push notifications through a client-side application. Some client-side applications, such as web-browser applications (e.g., Chrome, Firefox, etc.) may not support certain features to provide for secure storage of data and encryption keys that are used to provide for verification push notifications. For example, some client-side applications may utilize a local storage that stores data in plain text that can be easily accessed and read, thereby presenting a security threat. The web-client SDK provided by the authentication system provides for secure storage of data and encryption keys to enable a client-side application to securely provide verification push notifications.

### CROSS-REFERENCE TO RELATED APPLICATIONS

This application claims the benefit of priority of U.S. Provisional Application No. 63/147,037, filed on Feb. 8, 2021, which is incorporated herein by reference in its entirety.

### TECHNICAL FIELD

An embodiment of the present subject matter relates generally to verification and, more specifically, to verification push notifications provided through a web-browser application.

### BACKGROUND

Multi-factor authentication is commonly used to provide security against fraudulent use of online services. When using multi-factor authentication, a requested transaction (e.g., login request, money transfer, etc.) is granted only after two or more authentication requirements are satisfied. For example, a user may be prompted by the online service to provide a username and password, as well as confirm that the user is in possession of a previously registered device, such as a mobile phone. One way to verify possession of a registered device is through use of push notifications transmitted to the device. For example, the push notification transmitted to the registered device may prompt the user to confirm whether the user initiated the requested transaction. A public/private key pair can be used to verify that a response to the push notification was in fact generated and transmitted by the registered device. For example, the registered device uses the private key to digitally sign requested data that is returned along with the response. The corresponding public key can be used to authenticate that the digital signature was generated using the corresponding private key, indicating that the received data was in fact generated and transmitted by the registered device.

Current systems provide push notifications through use of secure native applications that provide for secure storage to maintain the security of the keys and other data used for authentication. Some online services, however, do not have a secure native application available and/or provide their services through a web site that can be accessed using web-browser applications (e.g., Chrome, Firefox). These types of applications may store data using a local storage in which the data is stored in plain text. This presents a security threat as data stored in the local storage can be easily accessed and read. Accordingly, improvements are needed.

### SUMMARY

An authentication system provides a web-client Software Development Kit (SDK) to enable verification push notifications through a client-side application. Some client-side applications, such as web-browser applications (e.g., Chrome, Firefox, etc.) may not support certain features to provide for secure storage of data and encryption keys that are used to provide for verification push notifications. For example, some client-side applications may utilize a local storage that stores data in plain text that can be easily accessed and read, thereby presenting a security threat. The web-client SDK provided by the authentication system provides for secure storage of data and encryption keys to enable a client-side application to securely provide verification push notifications.

An online service provider implements the web-client SDK into their web content (e.g., website) to utilize the multi-factor authentication functionality provided by the authentication system. To register a client device to receive verification push notifications, a user uses a client-side application executing on the client device to access web content (e.g., webpage) embedded with the web-client SDK. The web content enables the user to initiate an initialization process to register the client device as a registered device of the user and enables the client-side application executing on the client device to receive verification push notifications from the authentication system.

During the initialization process, the web-client SDK generates a primary encryption key (e.g., CryptoKey) that will be used along with an encryption algorithm to encrypt/decrypt information used to respond to authentication requests received from the authentication system. The primary encryption key is unique to the instance of the client-side application (e.g., Chrome) executing on the client device that is being used to perform the initialization process. For example, an instance of a different client-side application (e.g., Firefox) executing and/or installed on the client device would be initialized separately to obtain its own unique primary encryption key. Similarly, another instance of the same client-side application (e.g., Chrome) that is executing on a different client device would be initialized separately and receive its own unique primary encryption key.

Each primary encryption key may also be unique to the particular online service with which the client device is being registered. For example, unique primary encryption keys may be generated for each combination of the client-side application used to initiate the initialization process and online service to which the client-side application is being registered to receive verification push notifications. The primary encryption key is stored in a secure key store available to the web-browser application. For example, the primary encryption key may be stored in a secure key store, such as indexedDB.

The web-client SDK also generates a public/private key pair used to authenticate data transmitted between the client-side application and the authentication system. The public/private key pair is similarly stored in the secure key store. The web-client SDK provides the public key to the authentication system, however the private key is maintained by the registered client device in secret for use at the registered client device.

The authentication system generates unique factor information that is provided to the registered client device. The factor information includes secretive data that the authentication system requests from the registered client device during an authentication request associated with a requested transaction. The factor information may be digitally signed by the client device using the private key prior to transmission to the authentication system. The authentication system uses the corresponding public key to authenticate whether the returned factor information was digitally signed using the corresponding private key.

Some client-side applications use a local storage to store data in plain text. Storing the factor information in the local storage presents a security threat as the factor information may be easily accessed and read. To reduce this security threat, the factor information is encrypted using the primary encryption key prior to being stored in the local storage. The factor information may be appended with a key pair alias associated with the private/public key pair prior to being stored in the local storage. To access the factor information when responding to an authentication request, the encrypted data is accessed from the local storage and decrypted using the primary encryption key.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for providing verification push notifications through a client-side application, according to some example embodiments.

FIGS. 2A and 2B show communications within a system for providing verification push notifications through a client-side application, according to some example embodiments.

FIG. 3 is a flow diagram of a method for initializing a client-side application to provide verification push notifications, according to some example embodiments.

FIG. 4 is a flow diagram of a method for responding to an authentication request received via a verification push notification provided through a client-side application, according to some example embodiments.

FIG. 5 is a block diagram illustrating components of a machine, according to some example embodiments, able to read instructions from a machine-readable medium (e.g., a machine-readable storage medium) and perform any one or more of the methodologies discussed herein.

FIG. 6 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for providing verification push notifications through a client-side application. An authentication system provides a web-client SDK to enable verification push notifications through a client-side application, such as a web-browser application (e.g., Chrome, Firefox, etc.) that support certain features to provide for secure storage of data and encryption keys. The web-browser SDK provides mechanisms to safely store encryption keys and factor information used to respond to authentication requests. For example, encryption keys (e.g., primary encryption key, public/private key pair) are stored using a secure key store, such as indexedDb. Factor information is encrypted using a primary encryption key prior to being stored in a local storage. The primary encryption key is unique to the client-side application that is registered with an authentication system to receive verification push notifications. To access the factor information when responding to an authentication request, the encrypted data is accessed from the local storage and decrypted using the primary encryption key.

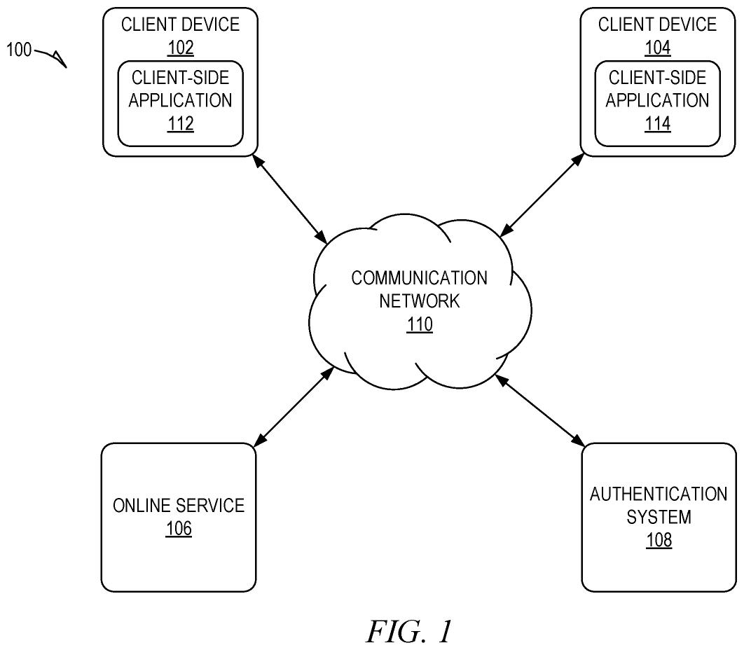

FIG. 1 shows a system 100 for providing verification push notifications through a client-side application, according to some example embodiments. As shown, multiple devices (i.e., client device 102, client device 104, online service 106 and authentication system 108) are connected to a communication network 110 and configured to communicate with each other through use of the communication network 110. The communication network 110 is any type of network, including a local area network (LAN), such as an intranet, a wide area network (WAN), such as the internet, a telephone and mobile device network, such as cellular network, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

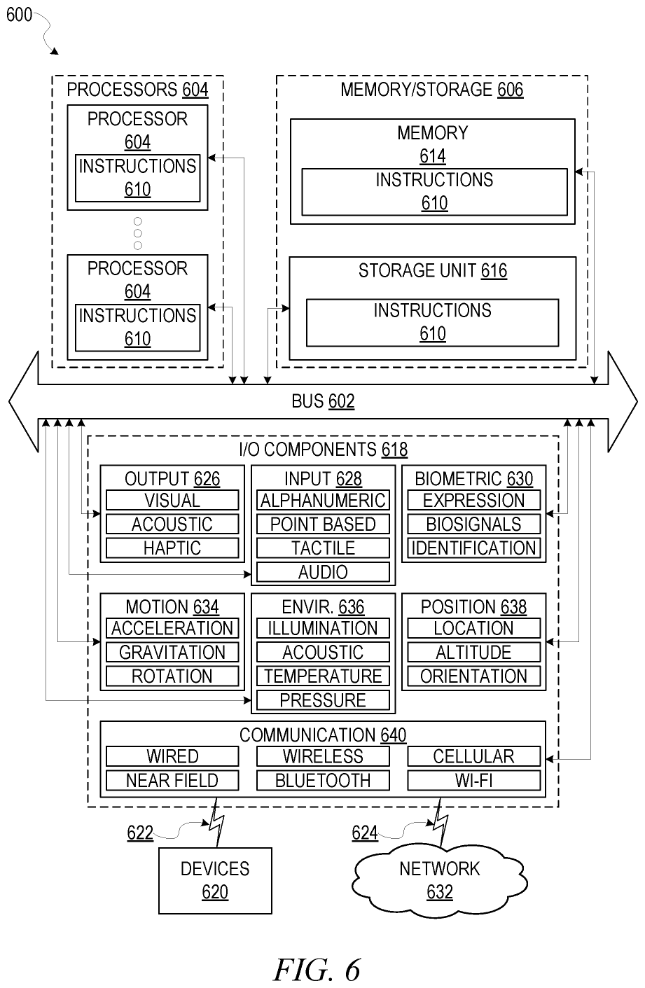

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 600 shown in FIG. 6.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

The online service 106 is one or more computing devices that provide an online service, such as a banking service, email service, retail service, travel service, and the like. Users communicate with and utilize the functionality provided by the online service 106 by using the client devices 102 and 104 that are connected to the communication network 110 by direct and/or indirect communication.

Although the shown system 100 includes only two client devices 102, 104 and one online service 106, this is only for ease of explanation and is not meant to be limiting. One skilled in the art would appreciate that the system 100 can include any number of client devices 102, 104 and/or online services 106. Further, each online service 106 may concurrently accept communications from and initiate communication messages and/or interact with any number of client devices 102, 104, and support connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user may interact with an online service 106 using a client-side application 112, 114, such as a web-browser (e.g., Chrome, Firefox), that resides on the client devices 102 and 104 and is configured to communicate with other computing systems. For example, the client-side application 112, 114 may provide a user interface that enables a user to access web content (e.g., a website) provided by the online service 106, such as by enabling the user to enter a Uniform Resource Locator (URL) identifying the website. The client-side application 112, 114 generates a request based on the provided URL to communicate with the online service 106 and access data defining the website. The client-side application 112, 114 may then render the received data on a display of the client device 102, 104 to present the requested website to the user. A user may use the user interface provided by the client-side application 112, 114 to further interact with the and utilize the functionality provided by the online service 106, such as by selecting links, navigating to other webpages, entering and submitting information, and the like.

Utilizing the functionality of the online service 106 may include requesting performance of various transactions. A transaction may be any type of requested action, such as logging into an account, transferring funds, purchasing an item, and the like. For example, a user may use the client-side application 112, 114 to communicate with the online service 106 to initiate a transaction request to perform a specified transaction. The online service 106 may condition approval of the requested transaction based on satisfaction of one or more authorization requirements. For example, the online service 106 may enforce an authorization requirement such as the user providing valid user credentials (e.g., username and password), correctly answering security questions, and the like.

The online service 106 may also enforce an authentication requirement based on a user having possession of a registered device. For example, the online service 106 may use the functionality of the authentication system 108 to transmit verification push notifications to a registered device (e.g., client device 102) through a client-side application 112. A verification push notification is transmitted to a registered client device 102, 104 that is registered to an account associated with the requested transaction. The verification push notification prompts the user to either confirm or deny the requested transaction. The verification push notification may be initiated through a client-side application 112, 114 executing on the client device 102, 104, such as a web-browser application, rather than a native application developed by the online service 106.

The online service 106 incorporates the functionality of the authentication system 108 through use of a web-client SDK provided for use by the authentication system 108. For example, the web-client SDK may be implemented into web content (e.g., a website) maintained by the online service 106. A user may use a client-side application 112, 114 executing on a client device 102, 104 to communicate with the online service 106 and access a web content embedded with the web-client SDK. This causes an instance of the web-client SDK to execute on the client device 102, 104. The web-client SDK executing on the client device 102, 104 may then initiate an initialization process on the client device 102, 104 to register the client device 102, 104 as a registered device, as well as enable the client-side application 112, 114 executing on the client device 102, 104 to receive verification push notification from the authentication system 108.

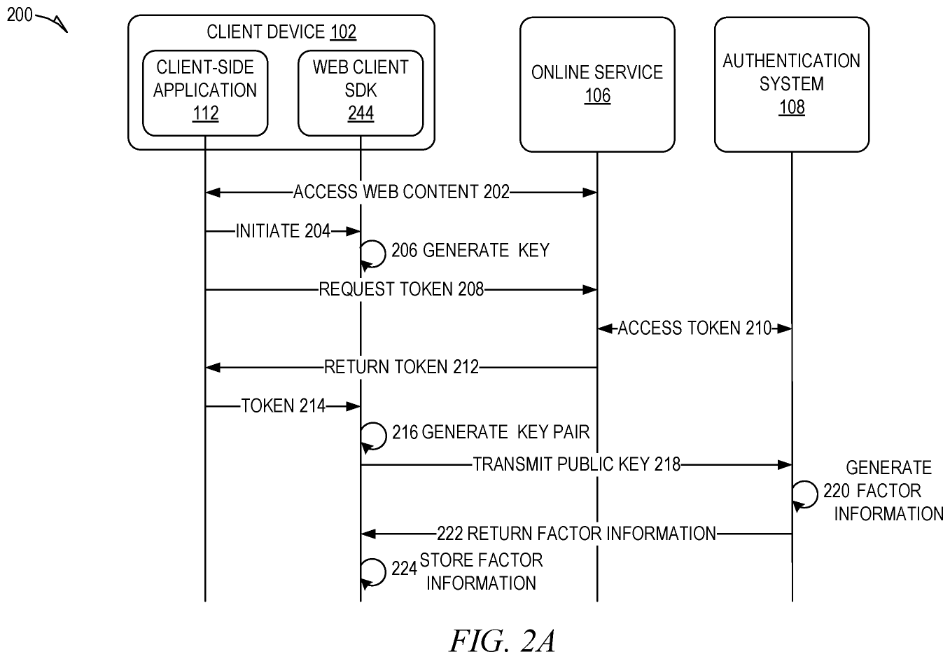

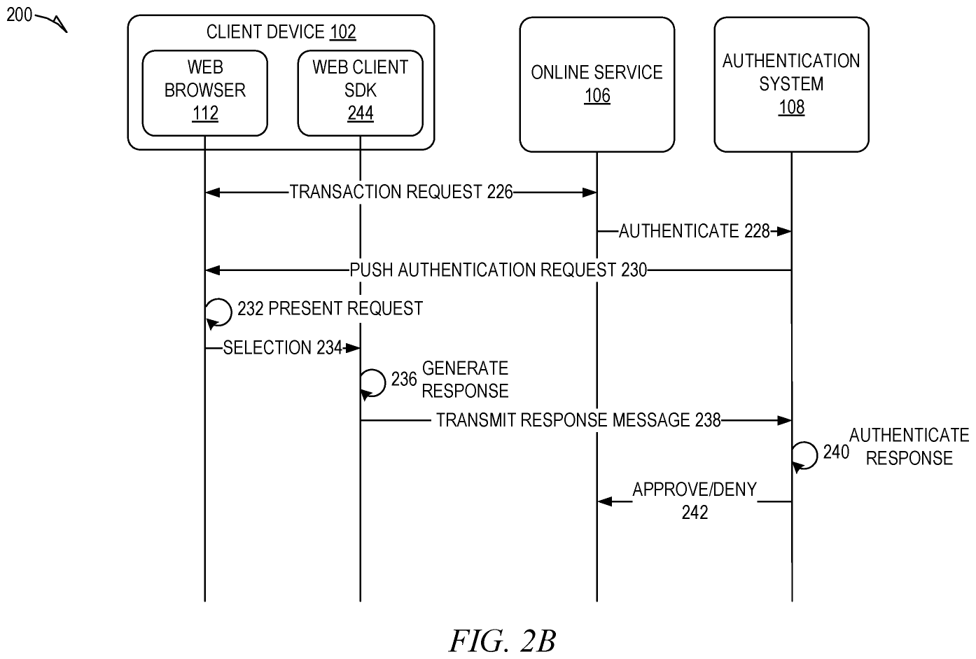

FIGS. 2A and 2B show communications within a system 200 for providing verification push notifications through a client-side application 112, according to some example embodiments. FIG. 2A shows communications for initializing a client device 102 as a registered device to receive verification push notifications through a client-side application 112. As shown, the client device 102 includes a client-side application 112 that enables the client device 102 to communicate and interact with the online service 106. For example, the client device 102 communicates 202 with the online service 106 to access web content (e.g., a webpage) maintained by the online service 106 that has been embedded with the web-client SDK 244. The communications 202 with the online service 106 includes transmitting a request to the online service 106 for the web content and receiving data defining the requested web content.

The client-side application 112 executes the received data to provide the requested web content (e.g., webpage) to a user of the client device 102. Executing the received data embedded with the web-client SDK 244 initiates an instance of the web-client SDK 244 on the client device 102.

The client-side application 112 transmits a command 204 to the web-client SDK 244 to initiate the initialization process and register the client-device 102 as a registered device. In response, the web-client SDK 244 generates 206 a primary encryption key (e.g., CryptoKey) for the client-side application 112. The primary encryption key is unique to the instance of the client-side application 112 executing on the client device 102. For example, an instance of a different web-browser application (not shown) executing and/or installed on the client device 102 would be initialized separately to obtain its own unique primary encryption key. Similarly, another instance of the same web-browser application that is executing on a different client device (not shown) would be initialized separately and receive its own unique primary encryption key.

The primary encryption key may also be unique to the particular online service 106 with which the client device is being registered. For example, unique primary encryption keys may be generated for each combination of the client-side application 112 used to initiate the initialization process and online service 106 to which the client-side application is being registered to receive verification push notifications. The primary encryption key is stored in a secure key store available to the client-side application 112. For example, the primary encryption key may be stored in a secure key store, such as indexedDB.

The client-side application 112 may also transmits a request 208 to the online service 106 for an access token to enable communication between the client-side application 112 and the authentication system 108 via an application programming interface (API) provided by the authentication system 108. In response to receiving the request 208, the online service 106 communicates 210 with the authentication system 108 to request/retrieve the access token, which the online service 106 then returns 212 to the client-side application 112.

The client-side application 112 may provide the access token to the web-client SDK 244 in a subsequent communication 214. The web-client SDK 244 generates 216 a public/private key pair used to authenticate data transmitted between the client-side application 112 and the authentication system 108. The public/private key pair is similarly stored in the secure key store.

The web-client SDK 244 provides the public key to the authentication system 108. For example, the web-client SDK 244 transmits a Hypertext Transfer Protocol (HTTP) request 218 including the public key to the authentication system 108. In response, the authentication system 108 generates 220 factor information that will be used by the authentication system 108 to authenticate messages received from the client-side application 112. The factor information may be any unique data used as a secret during authentication requests. For example, the factor information may be a unique string generated at random or generated based on specified data, such as a device identifier, service identifier, and the like.

The authentication system 108 transmits a communication 222 to the web-client SDK 244 that includes the factor information. In turn the web-client SDK 244 securely stores 224 the factor information for subsequent use during authentication requests.

Some client-side applications 112, such as web-browsers, use a local storage to store data in plain text. This presents a security threat as the factor information may be easily accessed and read. To reduce this security threat, the web-client SDK 244 encrypts the factor information using the primary encryption key prior to storing the factor information in the local storage. In some embodiments, the web-client SDK 244 appends the factor information with a key pair alias associated with the private/public key pair prior to storing the encrypted data in the local storage. To subsequently access the factor information for use when responding to an authentication request, the encrypted data is accessed from the local storage and decrypted using the primary encryption key.

FIG. 2B shows communications for authenticating a requested transaction with a verification push notification transmitted through a client-side application 112. A user may use a client-side application 112 to communicate 226 with the online service 106 to initiate a transaction request. For example, the user may request to perform a transaction such as logging into an account, transferring funds, purchasing an item, and the like. In turn, the online service 106 transmits a request 228 to the authentication system 108 to authenticate the requested transaction. The request 228 may include data identifying the requesting user, device or user account, as well as data describing the requested transaction.

In response to receiving the request 228, the authentication system 108 transmits an authentication request 230 to a client device 102 that is registered as a registered device of an account associated with the requested transaction. The authentication request 230 is transmitted as a push notification that is received via the client-side application 112 executing on the client device 102. The authentication request 230 may include data describing the requested transaction, such as the type of transaction being requested (e.g., login, transfer, purchase), an item associated with the requested transaction (e.g., an item being purchased), an amount associated with the requested transaction (e.g., a monetary price to purchase an item, a monetary amount to be transferred), and the like.

The client-side application 112 presents 232 the authentication request to the user on a display of the client device 102. This may include presenting the details of the requested transaction, as well as enabling the user to either approve or deny the requested transaction. For example, the authentication request may be presented with user interface elements (e.g., buttons) that enable the user to select to either approve or deny the requested transaction. The client-side application 112 communicates 234 the user's selection (e.g., approve, deny) to the web-client SDK 244.

In turn, the web-client SDK 244 generates 236 a response message 238 to be transmitted to the authentication system 108. The response message 238 indicates the user's selection to either approve or deny the request. To provide authentication that the response message 238 was transmitted by the registered device, the web-client SDK 244 uses the private key to digitally sign factor information that is returned in the response message 238. This may include a portion or all of the factor information. Further, the digital signature may be generated based on the factor information as well as some unique information related to the requested transaction, such as the transaction type, requested amount, and the like.

To access the factor information, the web-client SDK 244 accesses the primary encryption key from the secure data store and the encrypted data stored in the local storage. For example, the web-client SDK 244 uses the identifiers received in the authentication request to identify the appropriate primary encryption key and factor information. The web-client SDK 244 uses the primary encryption key to decrypt the encrypted data factor information accessed from the local storage. As explained earlier, the factor information stored in the local storage is appended with the key pair alias and encrypted using the primary encryption key. Decrypting the encrypted factor information therefore provides the web-client SDK 244 with the factor information and the keypair alias identifying the public/private key pair associated with the factor information.

The web-client SDK 244 generates a digital signature based on the factor information using the private key stored in the secure data store to generate 236 a response message 238. For example, the web-client SDK 244 uses the private key along with a hashing algorithm (e.g., Secure Hash Algorithm (SHA) 256) to generate a hash value based on the factor information, a portion thereof and, in some embodiments, transaction data describing the requested transaction. The web-client SDK 244 may also encrypt the resulting hash value using the private key along with an encryption algorithm. The web-client SDK 244 appends the encrypted hash value (e.g., digital signature) to the data used to generate the encrypted hash value (e.g., factor information, transaction data) as a digital signature, resulting in the digitally signed factor information.

The authentication system 108 authenticates 240 that the response message 238 was transmitted from the registered device. For example, the authentication system 108 uses the public key to decrypt the encrypted hash value appended to the factor information. The authentication system 108 then uses the public key along with the hashing algorithm to generate a hash value based on the received data used to generate the hash value (e.g., factor information, transaction data). The authentication system 108 compares the hash value generated from the digital signature to the hash value generated from the corresponding received data using the public key to authenticate whether the digital signature was generated using the private key corresponding to the public key. For example, matching hash values indicate that the private key used to generate the digital signature corresponds to the public key

The authentication system 108 may then transmit a command 242 to the online service 106 based on the results of the authentication request. For example, in the event that the response message 238 is properly authenticated, the authentication system 108 transmits a command 242 to the online service 106 to either approve or deny the requested transaction based on the selection made by the user. Alternatively, if the response message 238 cannot be properly authenticated, the authentication system 108 transmits a command 242 to the online service 106 to deny the requested transaction.

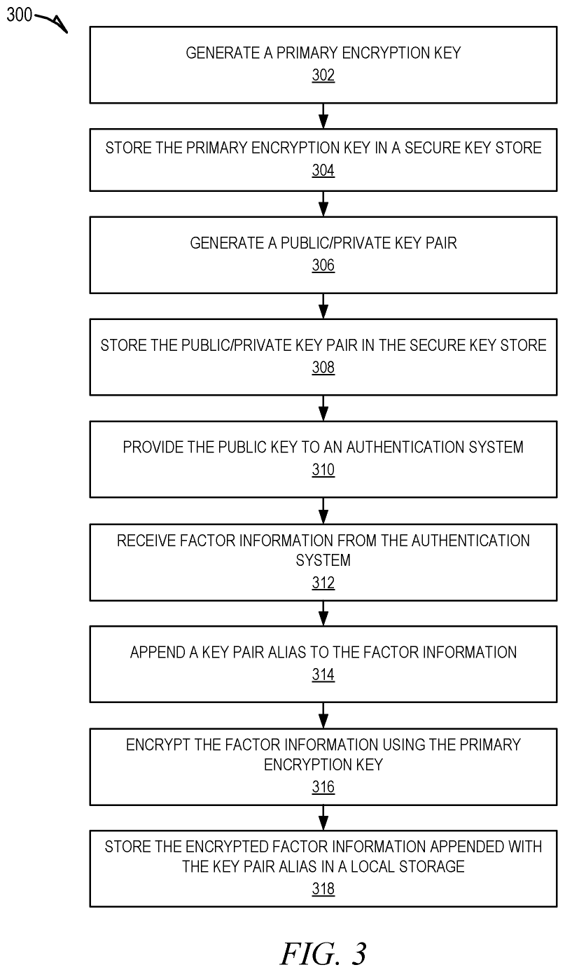

FIG. 3 is a flow diagram of a method for initializing a client-side application to provide verification push notifications, according to some example embodiments. The method 300 may be embodied in computer readable instructions for execution by one or more computer processors such that the operations of the method 300 may be performed in part or in whole by a client device 102; accordingly, the method 300 is described below by way of example with reference to the client device 102. However, it shall be appreciated that at least some of the operations of the method 300 may be deployed on various other hardware and/or software configurations and the method 300 is not intended to be limited to the client device 102.

At operation 302, a web-client SDK 244 generates a primary encryption key. In some embodiments, the primary encryption key is a CryptoKey. The primary encryption key is unique to the client-side application 112 instance that is being used to initialize a client device 102 as a registered device to receive verification push notifications. The primary encryption key may also be unique to the online service 106 to which the client-device 102 is being registered.

At operation 304, the web-client SDK 244 stores the primary encryption key in a secure key store. In some embodiments, the secure key store may be indexedDB.

At operation 306, the web-client SDK 244 generates a public/private key pair. The public/private key pair can be used to provide asymmetric cryptography for authenticating the source of data. For example, the public key can be used to encrypt data, which can only be decrypted using the corresponding private key, and vice versa. Similarly, the private key may be used to digitally sign data, which can only be verified using the public key.

At operation 308, the web-client SDK 244 stores the public/private key pair in the secure key store. For example, the secure key store may be indexedDB.

At operation 310, the client-side application 112 provides the public key to an authentication system 108.

At operation 312, the client-side application 112 receives factor information from the authentication system 108. The factor information is unique data that may be used during authentication requests.

At operation 314, the web-client SDK 244 appends a key pair alias to the factor information. The key pair alias identifies the public/private key pair associated with the factor information.

At operation 316, the web-client SDK 244 encrypts the factor information using the primary encryption key. For example, the web-client SDK 244 uses the primary encryption key along with an encryption algorithm to encrypt the factor information. In some embodiments, the web-client SDK 244 uses an encryption algorithm, such as AES-GCM, that uses an initial vector along with a key to encrypt data.

At operation 318, the web-client SDK 244 stores the encrypted factor information in a local storage. The local storage may only support strings. Accordingly, the web-client SDK 244 parses the encrypted factor information to string and then stores the resulting string in the local storage.

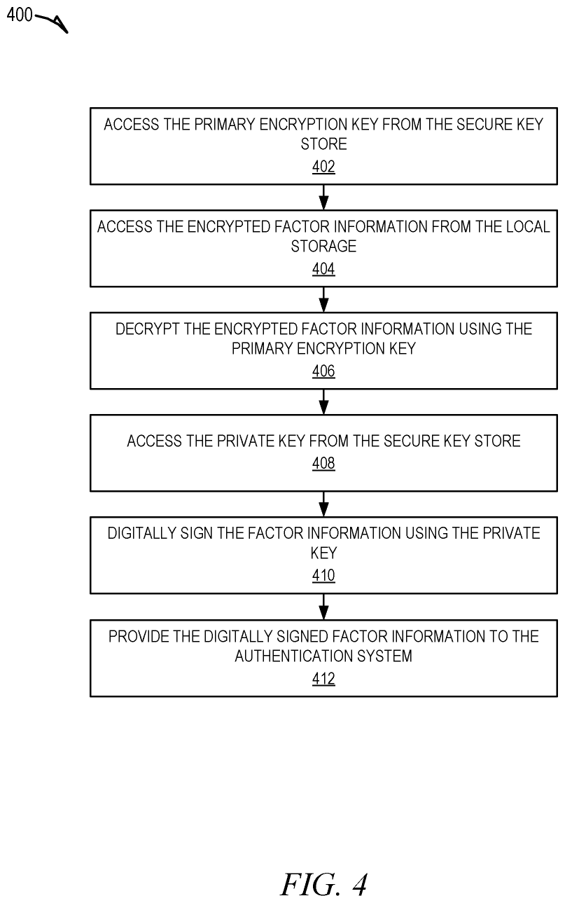

FIG. 4 is a flow diagram of a method for responding to an authentication request received via a verification push notification provided through a client-side application, according to some example embodiments. The method 400 may be embodied in computer readable instructions for execution by one or more computer processors such that the operations of the method 400 may be performed in part or in whole by a client device 102; accordingly, the method 400 is described below by way of example with reference to the client device 102. However, it shall be appreciated that at least some of the operations of the method 400 may be deployed on various other hardware and/or software configurations and the method 400 is not intended to be limited to the client device 102.

At operation 402, the web-client SDK 244 accesses a primary encryption key from the secure key store. For example, the web-client SDK 2454 may use an identifier associated with a verification push notification to access the corresponding primary encryption key. In some embodiments, the secure key store may be indexedDB.

At operation 404, the web-client SDK 244 accesses the encrypted factor information from the local storage. As previously discussed, the factor information can be appended with a key pair alias and encrypted using the primary encryption key prior to being stored in the local storage. Encrypting the factor information reduces a security risk associated with the stored factor information being accessed and read from the local storage.

At operation 406, the web-client SDK 244 decrypts the encrypted factor information using the primary encryption key. As the data stored in the local storage is stored as a string, the web-client SDK 244 may initially parse the string to a JSON object and then decrypt the data using the primary encryption key. In some embodiments, the data may be encrypted using an encryption algorithm, such as AES-GCM, that uses an initial vector along with a key to encrypt data. In this type of embodiment, the web-client SDK 244 identifies the initial vector from the parsed data and then uses the primary encryption key and initial vector along with the encryption algorithm to decrypt the factor information.

At operation 408, the web-client SDK 244 accesses the private key from the secure key store. For example, the web-client SDK 244 uses the key pair alias appended to the factor information to identify the correct private key.

At operation 410, the web-client SDK 244 digitally signs the factor information using the private key. For example, the web-client SDK 244 may use the private key along with a hashing algorithm (e.g., SHA 256) to generate a hash value based on the factor information or a portion thereof, as well as transaction data describing the requested transaction. The web-client SDK 244 may also encrypt the resulting hash value based on the private key. For example, the private key may be used along with an encryption algorithm to encrypt the hash value. The web-client SDK 244 appends the encrypted hash value to the data used to generate the hash value (e.g., factor information, transaction data) as a digital signature, resulting in the digitally signed factor information.

At operation 412, the web-client SDK 244 provides the digitally signed factor information to the authentication system 108. The authentication system 108 may use the corresponding public key to authenticate the digital signature appended to the received data (e.g., factor information, transaction data). For example, the authentication system 108 may use the public key to decrypt the encrypted hash value appended to the received data. The authentication system 108 may then use the public key along with the same hashing algorithm used by the web-client SDK 244 to generate a hash value based on the received data. The authentication system 108 compares the hash value generated from the digital signature to the hash value generated from the received data (e.g., factor information, transaction data) using the public key to authenticate whether the digital signature was generated using the private key corresponding to the public key. For example, matching hash values indicate that the private key used to generate the digital signature corresponds to the public key.

### Software Architecture

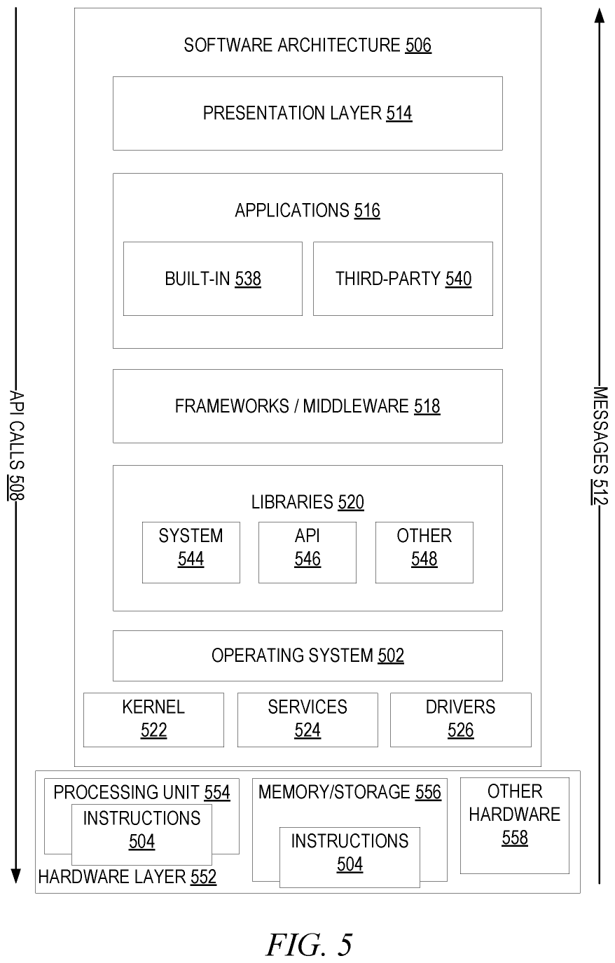

FIG. 5 is a block diagram illustrating an example software architecture 506, which may be used in conjunction with various hardware architectures herein described. FIG. 5 is a non-limiting example of a software architecture 506 and it will be appreciated that many other architectures may be implemented to facilitate the functionality described herein. The software architecture 506 may execute on hardware such as machine 600 of FIG. 6 that includes, among other things, processors 604, memory 614, and (input/output) I/O components 618. A representative hardware layer 552 is illustrated and can represent, for example, the machine 600 of FIG. 6. The representative hardware layer 552 includes a processing unit 554 having associated executable instructions 504. Executable instructions 504 represent the executable instructions of the software architecture 506, including implementation of the methods, components, and so forth described herein. The hardware layer 552 also includes memory and/or storage modules 556, which also have executable instructions 504. The hardware layer 552 may also comprise other hardware 558.

In the example architecture of FIG. 5, the software architecture 506 may be conceptualized as a stack of layers where each layer provides particular functionality. For example, the software architecture 506 may include layers such as an operating system 502, libraries 520, frameworks/middleware 518, applications 516, and a presentation layer 514. Operationally, the applications 516 and/or other components within the layers may invoke application programming interface (API) calls 508 through the software stack and receive a response such as messages 512 in response to the API calls 508. The layers illustrated are representative in nature and not all software architectures have all layers. For example, some mobile or special purpose operating systems may not provide a frameworks/middleware 518, while others may provide such a layer. Other software architectures may include additional or different layers.

The operating system 502 may manage hardware resources and provide common services. The operating system 502 may include, for example, a kernel 522, services 524, and drivers 526. The kernel 522 may act as an abstraction layer between the hardware and the other software layers. For example, the kernel 522 may be responsible for memory management, processor management (e.g., scheduling), component management, networking, security settings, and so on. The services 524 may provide other common services for the other software layers. The drivers 526 are responsible for controlling or interfacing with the underlying hardware. For instance, the drivers 526 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 520 provide a common infrastructure that is used by the applications 516 and/or other components and/or layers. The libraries 520 provide functionality that allows other software components to perform tasks in an easier fashion than to interface directly with the underlying operating system 502 functionality (e.g., kernel 522, services 524, and/or drivers 526). The libraries 520 may include system libraries 544 (e.g., C standard library) that may provide functions such as memory allocation functions, string manipulation functions, mathematical functions, and the like. In addition, the libraries 520 may include API libraries 546 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 520 may also include a wide variety of other libraries 548 to provide many other APIs to the applications 516 and other software components/modules.

The frameworks/middleware 518 (also sometimes referred to as middleware) provide a higher-level common infrastructure that may be used by the applications 516 and/or other software components/modules. For example, the frameworks/middleware 518 may provide various graphical user interface (GUI) functions, high-level resource management, high-level location services, and so forth. The frameworks/middleware 518 may provide a broad spectrum of other APIs that may be used by the applications 516 and/or other software components/modules, some of which may be specific to a particular operating system 502 or platform.

The applications 516 include built-in applications 538 and/or third-party applications 540. Examples of representative built-in applications 538 may include, but are not limited to, a contacts application, a browser application, a book reader application, a location application, a media application, a messaging application, and/or a game application. Third-party applications 540 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 540 may invoke the API calls 508 provided by the mobile operating system (such as operating system 502) to facilitate functionality described herein.

The applications 516 may use built in operating system functions (e.g., kernel 522, services 524, and/or drivers 526), libraries 520, and frameworks/middleware 518 to create UIs to interact with users of the system. Alternatively, or additionally, in some systems, interactions with a user may occur through a presentation layer, such as presentation layer 514. In these systems, the application/component “logic” can be separated from the aspects of the application/component that interact with a user.

FIG. 6 is a block diagram illustrating components of a machine 600, according to some example embodiments, able to read instructions 504 from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 610 (e.g., software, a program, an application, an applet, an app, or other executable code) for causing the machine 600 to perform any one or more of the methodologies discussed herein may be executed. As such, the instructions 610 may be used to implement modules or components described herein. The instructions 610 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 600 capable of executing the instructions 610, sequentially or otherwise, that specify actions to be taken by machine 600. Further, while only a single machine 600 is illustrated, the term “machine” shall also be taken to include a collection of machines that individually or jointly execute the instructions 610 to perform any one or more of the methodologies discussed herein.

The machine 600 may include processors 604, memory/storage 606, and I/O components 618, which may be configured to communicate with each other such as via a bus 602. The memory/storage 606 may include a memory 614, such as a main memory, or other memory storage, and a storage unit 616, both accessible to the processors 604 such as via the bus 602. The storage unit 616 and memory 614 store the instructions 610 embodying any one or more of the methodologies or functions described herein. The instructions 610 may also reside, completely or partially, within the memory 614, within the storage unit 616, within at least one of the processors 604 (e.g., within the processor's cache memory), or any suitable combination thereof, during execution thereof by the machine 600. Accordingly, the memory 614, the storage unit 616, and the memory of processors 604 are examples of machine-readable media.

The I/O components 618 may include a wide variety of components to receive input, provide output, produce output, transmit information, exchange information, capture measurements, and so on. The specific I/O components 618 that are included in a particular machine 600 will depend on the type of machine. For example, portable machines such as mobile phones will likely include a touch input device or other such input mechanisms, while a headless server machine will likely not include such a touch input device. It will be appreciated that the I/O components 618 may include many other components that are not shown in FIG. 6. The I/O components 618 are grouped according to functionality merely for simplifying the following discussion and the grouping is in no way limiting. In various example embodiments, the I/O components 618 may include output components 626 and input components 628. The output components 626 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 628 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 618 may include biometric components 630, motion components 634, environmental components 636, or position components 638 among a wide array of other components. For example, the biometric components 630 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 618 may include communication components 640 operable to couple the machine 600 to a network 632 or devices 620 via coupling 624 and coupling 622, respectively. For example, the communication components 640 may include a network interface component or other suitable device to interface with the network 632. In further examples, communication components 640 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 620 may be another machine or any of a wide variety of peripheral devices (e.g., a peripheral device coupled via a USB).

Moreover, the communication components 640 may detect identifiers or include components operable to detect identifiers. For example, the communication components 640 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 610 for execution by the machine 600, and includes digital or analog communications signals or other intangible medium to facilitate communication of such instructions 610. Instructions 610 may be transmitted or received over the network 632 using a transmission medium via a network interface device and using any one of a number of well-known transfer protocols.

“CLIENT DEVICE” in this context refers to any machine 600 that interfaces to a communications network 632 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 632.

“COMMUNICATIONS NETWORK” in this context refers to one or more portions of a network 632 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 632 or a portion of a network 632 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 610 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 610. The term “machine-readable medium” shall also be taken to include any medium, or combination of multiple media, that is capable of storing instructions 610 (e.g., code) for execution by a machine 600, such that the instructions 610, when executed by one or more computer processors 604 of the machine 600, cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 604) may be configured by software (e.g., an application 516 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 604 or other programmable processor 604. Once configured by such software, hardware components become specific machines 600 (or specific components of a machine 600) uniquely tailored to perform the configured functions and are no longer general-purpose processors 604. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 604 configured by software to become a special-purpose processor, the general-purpose processor 604 may be configured as respectively different special-purpose processors (e.g., comprising different hardware components) at different times. Software accordingly configures a particular processor or processors 604, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 602) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more computer processors 604 that are temporarily configured (e.g., by software) or permanently configured to perform the relevant operations. Whether temporarily or permanently configured, such processors 604 may constitute processor-implemented components that operate to perform one or more operations or functions described herein. As used herein, “processor-implemented component” refers to a hardware component implemented using one or more computer processors 604. Similarly, the methods described herein may be at least partially processor-implemented, with a particular processor or processors 604 being an example of hardware. For example, at least some of the operations of a method may be performed by one or more computer processors 604 or processor-implemented components. Moreover, the one or more computer processors 604 may also operate to support performance of the relevant operations in a “cloud computing” environment or as a “software as a service” (SaaS). For example, at least some of the operations may be performed by a group of computers (as examples of machines 600 including processors 604), with these operations being accessible via a network 632 (e.g., the Internet) and via one or more appropriate interfaces (e.g., an API). The performance of certain of the operations may be distributed among the processors 604, not only residing within a single machine 600, but deployed across a number of machines 600. In some example embodiments, the processors 604 or processor-implemented components may be located in a single geographic location (e.g., within a home environment, an office environment, or a server farm). In other example embodiments, the processors 604 or processor-implemented components may be distributed across a number of geographic locations.

“PROCESSOR” in this context refers to any circuit or virtual circuit (a physical circuit emulated by logic executing on an actual processor 604) that manipulates data values according to control signals (e.g., “commands,” “op codes,” “machine code,” etc.) and which produces corresponding output signals that are applied to operate a machine 600. A processor 604 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 604 may further be a multi-core processor having two or more independent processors 604 (sometimes referred to as “cores”) that may execute instructions 610 contemporaneously.

What is claimed is:

1. A method comprising:
receiving, by a client device, an authentication request from an authentication system via a verification push notification through a client-side application installed on the client device, the authentication request identifying a requested transaction;
in response to receiving an input identifying a selected response to the requested transaction, accessing a primary encryption key from a secure key store based on the authentication request;
decrypting encrypted factor information maintained by a local storage of the client device using the primary encryption key, yielding decrypted factor information, the decrypted factor information identifying a private key;
generating a response message based on the private key, the decrypted factor information, and the selected response to the requested transaction; and
transmitting the response message to the authentication system.

2. The method of claim 1, wherein generating the response message comprises:
generating a digital signature using the private key based on at least a portion of the decrypted factor information.

3. The method of claim 2, wherein the digital signature is further generated based on transaction data describing the requested transaction.

4. The method of claim 1, wherein the secure key store is IndexedDB.

5. The method of claim 1, wherein the client-side application is a web browser.

6. The method of claim 1, further comprising:
accessing, using the client-side application, web content from an online service, the web content being embedded with a web client Software Development Kit (SDK) for initializing client-side applications to receive verification push notifications; and
in response to receiving, via the web content, an input to initialize the client-side application to receive verification push notification from the online service, initiating an initialization process comprising:
generating the primary encryption key, the primary encryption key being unique to a combination of the client-side application installed on the client device and the online service.

7. The method of claim 6, wherein the initialization process further comprises:
generating a key pair including a public key and the private key; and
providing the public key to the authentication system.

8. The method of claim 7, further comprising:
receiving factor information from the authentication system; and
encrypting the factor information and data identifying the private key using the primary encryption key, yielding the encrypted factor information.

9. The method of claim 6, further comprising:
accessing, using the client-side application, second web content from a second online service, the second web content being embedded with the web client SDK for initializing client-side applications to receive verification push notifications; and
in response to receiving, via the second web content, an input to initialize the client-side application to receive verification push notifications from the second online service, initiating a subsequent initialization process comprising:
generating a second primary encryption key that is unique to a combination of the client-side application installed on the client device and the second online service.

10. The method of claim 6, further comprising:
accessing, using a second client-side application, the web content from the online service; and
in response to receiving, via the web content, an input to initialize the second client-side application to receive verification push notifications from the online service, initiating a subsequent initialization process comprising:
generating a second primary encryption key that is unique to a combination of the second client-side application installed on the client device and the online service.

11. A client device comprising:
one or more computer processors; and
one or more computer-readable mediums storing instructions that, when executed by the one or more computer processors, cause the client device to perform operations for providing an authentication request via a verification push notification through a client-side application, the operations comprising:
receiving the authentication request from an authentication system, the authentication request received via the verification push notification through the client-side application installed on the client device, the authentication request identifying a requested transaction;
in response to receiving an input identifying a selected response to the requested transaction, accessing a primary encryption key from a secure key store based on the authentication request;
decrypting encrypted factor information maintained by a local storage of the client device using the primary encryption key, yielding decrypted factor information, the decrypted factor information identifying a private key;
generating a response message based on the private key, the decrypted factor information, and the selected response to the requested transaction; and
transmitting the response message to the authentication system.

12. The client device of claim 11, wherein generating the response message comprises:
generating a digital signature using the private key based on at least a portion of the decrypted factor information.

13. The client device of claim 12, wherein the digital signature is further generated based on transaction data describing the requested transaction.

14. The client device of claim 11, wherein the secure key store is IndexedDB.

15. The client device of claim 11, wherein the client-side application is a web browser.

16. The client device of claim 11, the operations further comprising:
accessing, using the client-side application, web content from an online service, the web content being embedded with a web client Software Development Kit (SDK) for initializing client-side applications to receive verification push notifications; and
in response to receiving, via the web content, an input to initialize the client-side application to receive verification push notification from the online service, initiating an initialization process comprising:
generating the primary encryption key, the primary encryption key being unique to a combination of the client-side application installed on the client device and the online service.

17. The client device of claim 16, wherein the initialization process further comprises:
generating a key pair including a public key and the private key; and
providing the public key to the authentication system.

18. The client device of claim 17, the operations further comprising: receiving factor information from the authentication system; and
encrypting the factor information and data identifying the private key using the primary encryption key, yielding the encrypted factor information.

19. The client device of claim 16, the operations further comprising:
accessing, using the client-side application, second web content from a second online service, the second web content being embedded with the web client SDK for initializing client-side applications to receive verification push notifications; and
in response to receiving, via the second web content, an input to initialize the client-side application to receive verification push notifications from the second online service, initiating a subsequent initialization process comprising:
generating a second primary encryption key that is unique to a combination of the client-side application installed on the client device and the second online service.

20. A non-transitory computer-readable medium storing instructions that, when executed by one or more computer processors of a client device, cause the client device to perform operations comprising:
receiving an authentication request from an authentication system via a verification push notification through the client-side application installed on the client device, the authentication request identifying a requested transaction;
in response to receiving an input identifying a selected response to the requested transaction, accessing a primary encryption key from a secure key store based on the authentication request;
decrypting encrypted factor information maintained by a local storage of the client device using the primary encryption key, yielding decrypted factor information, the decrypted factor information identifying a private key;
generating a response message based on the private key, the decrypted factor information, and the selected response to the requested transaction; and
transmitting the response message to the authentication system.
